(19) United States
(12) Patent Application Publication
(10) Pub. No.: US 2009/0208898 A1
(43) Pub. Date: Aug. 20, 2009

(54) Fluid jet bristle aggitation toothbrush fixture

(76) Inventor: Glen Kaplan, Daytona Beach, FL (US)

Correspondence Address: PATENT LAW & VENTURE GROUP, 2424 S.E. BRISTOL, SUITE 300, NEWPORT BEACH, CA, 92660, US

(21) Appl. No.: 12/229,811

(22) Filed: Aug. 26, 2008

Related U.S. Application Data
(60) Provisional application No. 61/065,961, filed on Feb. 15, 2008.

(51) Int. Cl. A61C 17/02; A46B 13/00; A46B 9/04; A61C 17/00

(52) U.S. Cl. 433/80; 15/22.1; 15/167.1; 433/216

(57) ABSTRACT

A U-shaped mouthpiece joined with a delivery tube engaged at one of its ends and with a handle at an opposing end. The mouthpiece has an outer wall enclosing a hollow space, the outer wall configured as either one or two wells, each sized for receiving plural teeth. A plurality of apertures in the outer wall are positioned and extensive for directing a fluid within the hollow space into the well as jet steams. A plurality of bristles are mounted on the outer wall within the well in positions for fluid impingement by the fluid exiting the apertures. A fluid pump pressurizes the mouthpiece to enable the jet streams to impinge on the bristles so as to scour the teeth.

### CROSS-REFERENCE TO RELATED APPLICATIONS

This application is a non-provisional application describing the same invention as a co-pending provisional application, Ser. No. 61/065,961, filed on Feb. 15, 2008, and hereby claims date priority therefrom, the provisional application hereby being incorporated herein by reference.

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### INCORPORATION-BY-REFERENCE OF MATERIAL SUBMITTTED ON A COMPACT DISC

Not applicable.

### REFERENCE TO A “MICROFICHE APPENDIX”

Not applicable.

### BACKGROUND OF THE INVENTION

1. Field of the Present Disclosure

This disclosure relates generally to the field of toothbrushes and, more particularly, to a teeth cleaning apparatus capable of simultaneously brushing a full set of teeth.

2. Description of Related Art Including Information Disclosed Under 37 CFR 1.97 and 1.98

Barnes, U.S. Pat. No. 8,871,81, discloses a toothbrush comprising a substantially U-shaped back of a size sufficient to encompass a user's teeth, the U-shaped back being provided on the inner surface thereof with suitable bristles or brush material, the bristles under the upper portion of the back diminishing in length from the outer to the inner edge of the back and the bristles on the lower portions of the back increasing in length toward the lower ends of the back.

Goldberg, U.S. Pat. No. 1,707,118, discloses a toothbrush comprising a U-shaped head having grooves provided in its free longitudinal edges, inwardly extending bristles on the head and yieldable massage elements provided with ribs for reception in the respective grooves.

Martin, U.S. Pat. No. 3,380,446, discloses a jacket assembly for treating the teeth and gums comprising a jacket for one of the jaws including a non-permeable flexible trough adapted to surround the teeth and a portion of the gums, a non-permeable seal secured to the edge of the trough for providing a liquid seal between the trough edge and the gums, an entrance conduit connected to the jacket for sending a liquid into the space between the teeth and the trough, an exit conduit also connected to the jacket for discharging the liquid after it has traversed a portion of the trough space, and a plurality of transducers coupled to a source of alternating current power for applying sonic vibrations to the liquid and to the teeth, the transducers positioned adjacent to the inside surface of the trough.

Kelly, U.S. Pat. No. 3,731,675, discloses an apparatus for cleaning and polishing teeth and particularly the interproximal surfaces and gingival crevices thereof wherein a mouthpiece adapted to fit over at least a portion of the dentition and sealably engage the gums includes a plurality of interiorly disposed spaced inlet and exhaust ports in communication with a source of fluid or other cleansing material and an evacuation pump, respectively, such that the cleansing material is turbulently drawn against, between and around the teeth by suction to remove small food particles, bacteria and bacterial plaque, bacterial matt or organized bacteria and polish all exposed tooth surfaces to promote recalcification by normal defense mechanisms of the body without the cleansing materials and foreign matter being forced into or entrapped under the soft tissues of the mouth.

Kennedy, U.S. Pat. No. 4,011,616, discloses a vibrating toothbrush comprising a soft shoe bristled on one side and having a metal structural skeleton. The shoe is capable of being formed over a human dental arch so that the bristles will be in contact with the teeth. The shoe can be detachably connected to a horseshoe-shaped base which in turn is connected to a vibrating apparatus.

Quinby, U.S. Pat. No. 4,164,940, discloses an apparatus for cleaning teeth and the gingival crevices and for massaging the gums. The apparatus comprises a mouthpiece having an upper channel member adapted to fit over at least a part of the upper dentation and to snugly engage the upper gum and a lower channel member adapted to fit over at least a part of the lower dentation and to snugly engage the lower gum. The upper and lower channels are joined by a membrane means which form fluid chambers. Pneumatic means are provided to move the upper and lower channel members upward and downward over the respective gums to massage the gums. In addition water or any suitable cleaning fluid is introduced into and out of the apparatus to clean the teeth and gingival crevices and to provide lubrication for the massaging action of the pneumatic means.

Solow, U.S. Pat. No. 4,224,710, discloses a power-actuated toothbrush adapted to brush both sides of a tooth and penetrate into the embrasures. The bristles extend at an angle to the sides of the teeth whereby the bristles of the brush also enter and clean the sulcus area. In preferred embodiments of the invention, the biting surfaces of the teeth are cleaned simultaneously with the sides of the teeth. In other embodiments of the invention, an entire dental arch or even the entire mouth of teeth is cleaned in a single operation.

Kelly et al., U.S. Pat. No. 4,237,574, discloses a tooth cleaning apparatus having a structurally rigid tray including a U-shaped channel for the reception therein of teeth carried by a jaw member. The cleaning means is also included in associated relationship with the tray. Secured to the outer surface of the tray at a point opposite the open side thereof are resilient pads of predetermined length to enable mechanical interengagement with the teeth to effect securing of the tray to the opposite jaw member from the teeth being cleaned. Included within the interior of the U-shaped channel are a predetermined number of stop elements positioned to limit the depth to which the jaw may be inserted and to assure proper alignment of the teeth and sulcus with the tray. In one embodiment of the apparatus, the interior of the U-shaped channel is provided with a plurality of brush bristles to effectuate brushing the teeth as well as cleaning the sulcus. Another embodiment of the apparatus has cleaning means which include ultrasonic energy producing mechanisms. An embodiment utilizing ultrasonic energy effects cleaning through the movement of the brush bristles relative to the tooth surfaces, whereas the embodiment without ultrasonic energy achieves the cleaning operation through a mechanical chewing function performed by the person. In a further variation of the apparatus, fluid conducting means are provided for transmitting ultrasonic energy from the producing devices to the surfaces of the teeth and to the region of the sulcus.

McKinley, U.S. Pat. No. 5,104,315, discloses a mouthpiece for a dental hygiene apparatus formed of a relatively rigid tray having a plurality of orifices connected by tubes to a source of dental cleaning solution, a vacuum source, and a vent. A first group of the orifices are selectively formed and positioned in the tray such that they lie adjacent the interproximal crevices of the teeth. These orifices are connected to the source of cleaning solution. A second group of orifices, which are substantially larger in diameter and fewer in number than the first orifices, are connected to the vacuum source for evacuating the cleaning solution and other substances from the mouth. The second orifices are formed in the tray in a position which is inferior to (i.e., below) the first orifices. A pair of third orifices are formed in the tray superior to (i.e., above) the first orifices, and are connected to a vent to prevent formation of a vacuum within the mouth during operation. The apparatus further includes a vacuum operated valve for allowing user control of the flow of cleaning solution to the mouthpiece. An additional source of cleaning solution, such as a foam presoak, may be provided through one or more of the orifices. Another aspect of the invention involves an apparatus and method for selecting one of a plurality of different size mouthpieces for use by a prospective user. The sizing apparatus includes a bite registration device and one or more templates.

Rabinowitz, U.S. Pat. No. 5,175,901, discloses an apparatus for brushing an entire arch of teeth at once that has a resilient U-shaped housing containing a channel within which the arch of teeth fits. A plurality of bristles substantially covers the surface area of the channel, and a handle extends from each arm of the housing. The channel is shaped whereby the bristles on the edges of the channel are angled into the gingival sulcus. In operation, the user grasps a handle in each hand and moves the handles in opposition to each other to move the resilient housing. This causes the bristles to move, thereby brushing the teeth in an effective manner.

Krasner et al., U.S. Pat. No. 5,337,435, discloses an automatic toothbrush that enables a user to brush all teeth of an arch simultaneously. A toothbrush portion includes a set of brushes arranged in an arc shaped to coincide with the shape of the user's mouth. The toothbrush includes side brushes for brushing the sides of the user's teeth, and occlusal brushes for brushing the biting surfaces of the teeth. All of the brushes are connected together by gears, so that rotation of one of the gears causes rotation of all of the brushes. The toothbrush includes a handle which contains a motor, the motor being connected to a drive shaft which engages one of the gears. The toothbrush also includes a display screen which is connectable to the handle, and which provides educational material or entertainment to the user while the toothbrush is in use. Also, the display screen may supply feedback to the user concerning the amount of plaque remaining on the teeth, or concerning some other aspect of the quality of the brushing.

Viskup, U.S. Pat. No. 5,443,386, discloses a customized tooth cleansing device equipped with bristles whose orientation, length, and flexibility is customized to the dental characteristics of the user so as to provide proper penetration of the periodontal pockets. The device is equipped with a conduit for irrigating the mouth of the user with a cleansing, medicinal, or antibiotic solution. The device is molded to accommodate the particular dental characteristics of the user, and is equipped with a seal to prevent escape of the irrigating solution.

Lee, U.S. Pat. No. 6,223,376, discloses a toothbrush comprising a toothbrush body having a handle and a first vibration generating section and possessing a first groove which has substantially a U-shaped contour; an intermediate engaging member detachably engaged into the first groove of the toothbrush body, having substantially a U-shaped configuration, and possessing a second groove which has substantially a U-shaped contour; a bristle holder having anchored thereto a plurality of bristles, the bristle holder including a teeth cleaning section and a tongue cleaning section; the teeth cleaning section being detachably fitted into the second groove of the intermediate engaging member, having substantially a U-shaped configuration, and possessing a third groove which has substantially a U-shaped contour to receive therein upper or lower teeth of a person; and the tongue cleaning section integrally coupled to a curved portion of the teeth cleaning section for removing a coating existing on a surface of the tongue of the person.

Berge, U.S. Pat. No. 6,353,956, discloses a U-shaped, ultrasonic toothbrush module to be used with currently available ultrasonic toothbrush hand pieces made of soft thermoplastic, silicone, or latex material with upper and lower bridge receiving spaces formed on opposite sides. The receiving spaces are designed to receive a user's upper and lower bridges when placed into the user's mouth. Disposed on the three inside surfaces of each receiving space are a plurality of bristles which completely contact the exposed surfaces of every tooth when the device is used. The module includes a housing with a pivoting T-shaped member and magnets attached at one end that connects to a standard ultrasonic toothbrush hand piece. Motion generated by the hand piece is transmitted through the T-shaped member and to the U-shaped member. The movement of the U-shaped member generates ultrasonic waves that are transmitted to the surfaces of the teeth and move the brushes when teeth are placed into the upper and lower bridge receiving spaces.

Reizenson, U.S. Pat. No. 6,893,259, discloses an oral hygiene device including, in combination, a system for relatively effortlessly and effectively cleansing dental, inter-dental, gingival and deep-gum surfaces and crevices, and a convenient teeth bleaching system that may be selectively implemented following cleansing of the oral surfaces, wherein the present invention may be utilized in conjunction with, or in lieu of, conventional brushing and/or flossing practices.

Inoue et al., U.S. Pat. No. 7,118,377, discloses a dental system for cleaning a user's teeth and marginal gingiva with a drug solution that includes a mouthpiece made for each user and having substantially the same shape as the teeth and the marginal gingiva of the user. The mouthpiece is designed to produce a gap between the mouthpiece and the teeth together with the marginal gingiva when placed to cover the teeth and the marginal gingiva of the user. The dental system also includes a drug solution supply unit and a drain unit, both connected to the mouthpiece, and a suction unit connected to the drain unit. The mouthpiece adheres to the marginal gingiva by a suction applied from the suction unit. The dental system cleans the teeth and the marginal gingiva with a stream of the drug solution flowing through the gap.

The related art described above discloses teeth cleaning apparatuses having U-shaped cross sections configured for simultaneously cleaning an occlusal surface, a facial surface, and a lingual surface of a set of teeth. However, the prior art fails to disclose an apparatus capable of simultaneously cleaning a full set of teeth using fluid jets to agitate bristles that are in contact with tooth surfaces. The present disclosure distinguishes over the prior art providing heretofore unknown advantages as described in the following summary.

### BRIEF SUMMARY OF THE INVENTION

This disclosure teaches certain benefits in construction and use which give rise to the objectives described below.

A U-shaped mouthpiece is joined with a delivery tube engaged at one of its ends and with a handle at an opposing end. The mouthpiece has an outer wall enclosing a hollow space, the outer wall configured with either one or two wells, each sized for receiving plural teeth and preferably the upper and lower sets of teeth in a person's mouth. A plurality of apertures in the outer wall are positioned and extensive for directing a fluid within the hollow space into the wells as jet steams. A plurality of bristles are mounted on the outer wall within the wells in positions for fluid impingement by the fluid exiting the apertures. A fluid pump pressurizes the mouthpiece to enable the jet streams to impinge on the bristles so as to scour the teeth as the bristles move and as the fluid moves preferably in pulses.

A primary objective inherent in the above described apparatus and method of use is to provide advantages not taught by the prior art.

Another objective is to clean a full set of teeth within a person's mouth simultaneously.

A further objective is to clean a full set of teeth without requiring complex mechanical or manual actuation.

A further objective is to use fluid impingement to scour the surfaces of a full set of teeth simultaneously.

A further objective is to use fluid impingement to manipulate tooth brushing bristles to scour the surfaces of a full set of teeth simultaneously.

Other features and advantages of the present invention will become apparent from the following more detailed description, taken in conjunction with the accompanying drawings, which illustrate, by way of example, the principles of the presently described apparatus and method of its use.

### BRIEF DESCRIPTION OF THE SEVERAL VIEWS OF THE DRAWING(S)

Illustrated in the accompanying drawing(s) is at least one of the best mode embodiments of the present invention In such drawing(s):

FIG. 1 is a an elevational view of the presently described apparatus with a handle thereof shown in vertical section;

FIG. 2 is a perspective view of a mouthpiece thereof;

FIG. 3 is a cross-sectional view thereof taken at line A-A in FIG. 2, showing an “H” shaped embodiment thereof;

FIG. 4 is a cross-sectional view thereof taken at line A-A showing a “U” shaped embodiment thereof;

FIG. 5 is a cross-sectional view thereof taken at line B-B in FIG. 2, showing a frontal portion of the present invention within a user's mouth, with a portion of a delivery tube extending from the user's mouth and with the person's lips sealing around the delivery tube, and further showing the positions of upper and lower front teeth in the mouthpiece and the position of a return suction tube for drawing fluid in the person's mouth into the delivery tube;

FIG. 6 is a schematic diagram of a delivery pump circuit of the present invention.

### DETAILED DESCRIPTION OF THE INVENTION

The above described drawing figures illustrate the described apparatus and its method of use in at least one of its preferred, best mode embodiment, which is further defined in detail in the following description. Those having ordinary skill in the art may be able to make alterations and modifications to what is described herein without departing from its spirit and scope. Therefore, it should be understood that what is illustrated is set forth only for the purposes of example and should not be taken as a limitation on the scope of the present apparatus and its method of use.

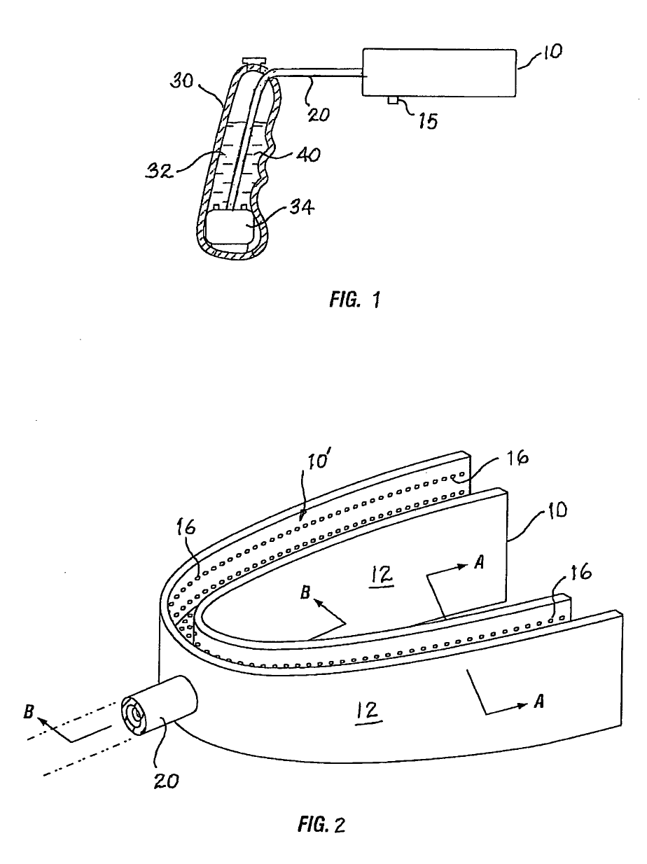

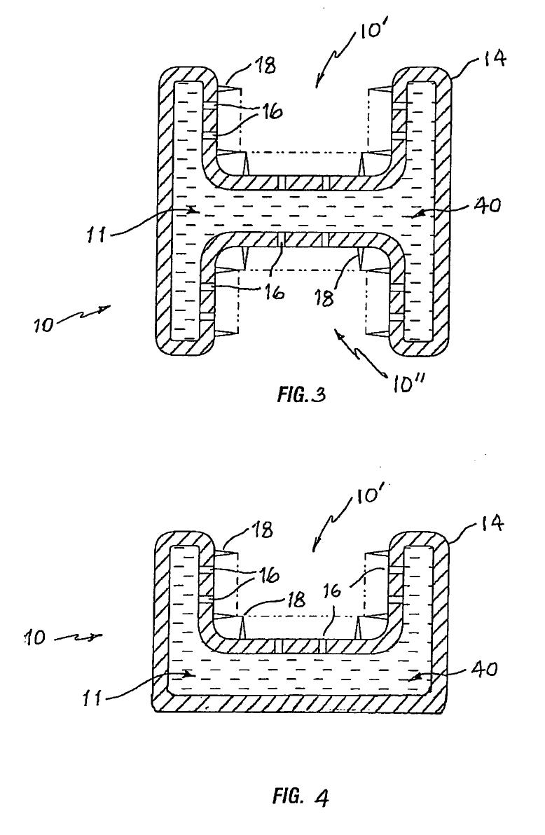

The present invention comprises a mouthpiece 10, a delivery tube 20 and a handle 30 as shown in FIG. 1. The mouthpiece 10 takes the form of a full-mouth tooth scrubbing device having a “U” shape, as shown in FIG. 2. Mouthpiece 10 is preferably made of a rigid material covered with a softer material on its outer surface 12, and in a first embodiment, as shown in FIG. 3, taken at line A-A in FIG. 2, mouthpiece 10 may have an “H” shape in cross-section. In an alternate embodiment, the cross-section may be, as shown in FIG. 4, “U” shaped. The “H” shape configuration enables cleaning both upper teeth and lower teeth simultaneously. The “U” shape configuration enables cleaning upper and lower teeth in sequence.

In FIG. 3 we see that the mouthpiece 10 has a hollow space 11 which contains an interior fluid 40 contained within an outer wall 14. When mouthpiece 10 is inserted into a user's mouth, the upper teeth are inserted into upper well 10′ and the lower teeth are inserted into the lower well 10″. The side and bottom walls (part of outer wall 14) of the wells 10′ and 10″ have apertures 16 which communicate between hollow space 11 and the wells 10′, 10″. The outer surface 12 within the wells 10′ and 10″ provide bristles 18 which extend from outer surface 12 normally as shown. For clarity, bristles 18 are not shown in FIG. 2.

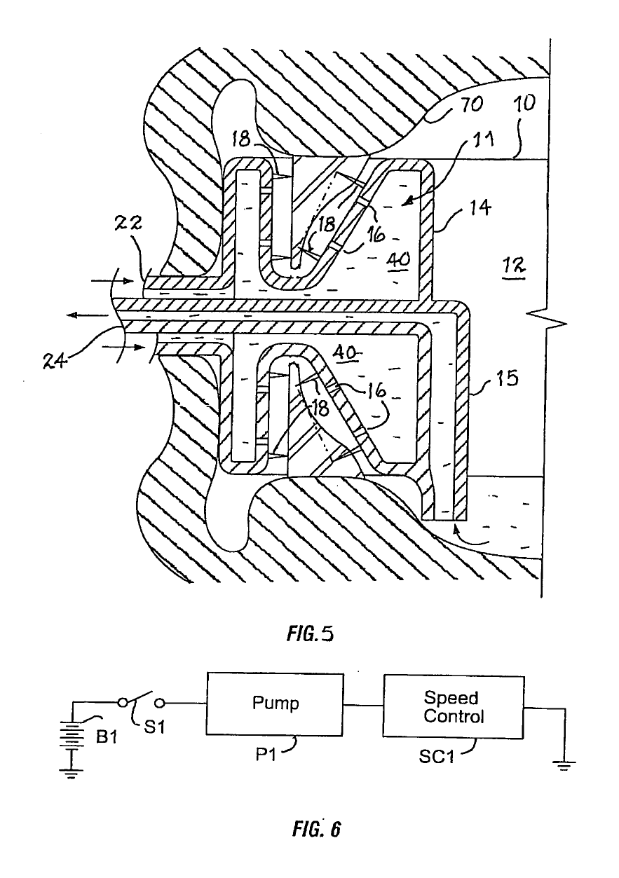

In FIG. 5 we see that delivery tube 20 is preferably a double tube with coaxial arrangement. Outer tube wall 22 provides fluid inflow, while inner tube wall 24 provides for fluid flowing out of the hollow space 11 of mouthpiece 10. Fluid entering mouthpiece 10 fills hollow space 11 creating a static pressure uniformly distributed against outer wall 14. A suction tube 15 is mounted as shown in FIG. 5 for drawing the fluid 40 from the user's mouth 70 to inner tube wall 24.

The handle shown in FIG. 1 contains a reservoir 32 for fluid 40 and a fluid pumping circuit 34. Fluid 40 returning to the handle 30 through tube 20 is delivered to reservoir 32. Fluid pump P1, part of pumping circuit 34 draws from reservoir 32 to pressurize outer tube wall 22 thereby driving fluid 40 to mouthpiece 10 as previously discussed. FIG. 6 shows the elements that are part of pumping circuit 34. Battery B1 is connected through switch S1 to pump P1 and speed control SC1. Speed control SC1 is enabled for adjusting fluid pressure and pulsation rate.

The present invention, as noted in a first embodiment, is used for scrubbing the surfaces of all of the teeth in a user's mouth at once. In operation, the mouthpiece 10 is placed within the mouth and, in the H-shaped first embodiment, the upper and lower teeth are inserted into the wells 10′ and 10″ respectively. The teeth do not bear down on the surfaces of the wells 10′ and 10″ as room for bristle movement is necessary. Fluid pressure within mouthpiece 10 forces fluid 40 to move through apertures 16 and emerge as fluid jets. The fluid jets are directed against the surfaces of the user's teeth and also against the bristles 16. The bristles 16 are thereby moved back and forth by the fluid jets and, this back and forth motion, scours the tooth surfaces as if a manual toothbrush were being moved across the teeth. The impingement of the fluid 40 against tooth surfaces and into interproximal spaces between the teeth helps to scour the teeth surfaces and to loosen and dislodge food particles and plaque. The fluid pump 34 may be adapted for providing a sinusoidal pumping action so that the water jets are intermittent. When the natural pendulosity of the bristles 16 is matched with the sinusoidal pumping action and movement of fluid 40, a synergistic movement of the bristles 16 is attained which provides a highly efficient cleaning action since spring forces within the bristles 16 act in concert with impingement forces of the pulsed fluid jets to produce maximum bristle range of motion.

It is recommended by the America Dental Association to brush at least two minutes with a standard tooth brush. Since the adult mouth has 32 teeth, one may assume that each tooth receives one-thirty-second of the two minutes, or 3.75 seconds of brushing time. Since a traditional manual brush generally brushes only one of the three exposed sides (surfaces) of a tooth at once, each tooth surface receives only about 1.25 seconds of bristle contact. Since all of the teeth surfaces of all of the teeth are brushed by the present invention simultaneously, the total time for brushing need only be a few seconds to achieve parity with a the traditional toothbrush. The fluid used with the present invention is preferably a beta powder of tricalcium phosphate offered by Brain Base, Corp, or Phrophyflex® from Kavo, Inc. Both of these products use a micro-particle solution that won't clog the apertures 16 in the mouthpiece 10 but will effectively scour tooth enamel without producing wear.

The enablements described in detail above are considered novel over the prior art of record and are considered critical to the operation of at least one aspect of the apparatus and its method of use and to the achievement of the above described objectives. The words used in this specification to describe the instant embodiments are to be understood not only in the sense of their commonly defined meanings, but to include by special definition in this specification: structure, material or acts beyond the scope of the commonly defined meanings. Thus if an element can be understood in the context of this specification as including more than one meaning, then its use must be understood as being generic to all possible meanings supported by the specification and by the word or words describing the element.

The definitions of the words or drawing elements described herein are meant to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements described and its various embodiments or that a single element may be substituted for two or more elements in a claim.

Changes from the claimed subject matter as viewed by a person with ordinary skill in the art, now known or later devised, are expressly contemplated as being equivalents within the scope intended and its various embodiments. Therefore, obvious substitutions now or later known to one with ordinary skill in the art are defined to be within the scope of the defined elements. This disclosure is thus meant to be understood to include what is specifically illustrated and described above, what is conceptually equivalent, what can be obviously substituted, and also what incorporates the essential ideas.

The scope of this description is to be interpreted only in conjunction with the appended claims and it is made clear, here, that each named inventor believes that the claimed subject matter is what is intended to be patented.

What is claimed is:

1. A fluid jet bristle aggitation toothbrush fixture comprising:
a U-shaped mouthpiece having an H-shaped cross section;
a delivery tube engaged at one end thereof with the mouthpiece, and at an opposing end thereof with a handle;
the mouthpiece having an outer wall enclosing a hollow space therein, the outer wall configured as an upper well, and in opposition thereto, a lower well, the wells sized for receiving an upper set of teeth and a lower set of teeth respectively;
a plurality of apertures in the outer wall, the apertures positioned and extensive for directing a fluid within the hollow space into the wells;
a plurality of bristles mounted on the outer wall within the wells in positions for fluid impingement by the fluid exiting the apertures;
a means for pressurizing the fluid in the hollow space, the pressurizing means positioned within the handle.

2. The fluid jet bristle aggitation toothbrush fixture of claim 1 wherein the delivery tube has an outer tube wall concentric with an inner tube wall, wherein the fluid is moved into and out of the mouthpiece through the inner and outer tube walls simultaneously.

3. The fluid jet bristle aggitation toothbrush fixture of claim 1 wherein the pressurizing means is a fluid pump.

4. The fluid jet bristle aggitation toothbrush fixture of claim 1 wherein the handle provides a fluid reservoir.

5. The fluid jet bristle aggitation toothbrush fixture of claim 1 wherein the fluid pump is enabled for pulsation pumping of the fluid.

6. A fluid jet bristle aggitation toothbrush fixture comprising:
a U-shaped mouthpiece having a U-shaped cross section;
a delivery tube engaged at one end thereof with the mouthpiece, and at an opposing end thereof with a handle;
the mouthpiece having an outer wall enclosing a hollow space therein, the outer wall configured as a well sized for receiving one of an upper set of teeth and a lower set of teeth;
a plurality of apertures in the outer wall, the apertures positioned and extensive for directing a fluid within the hollow space into the wells;
a plurality of bristles mounted on the outer wall within the well in positions for fluid impingement by the fluid directed there onto by the apertures;
a means for pressurizing the fluid in the hollow space, the pressurizing means positioned within the handle.

7. The fluid jet bristle aggitation toothbrush fixture of claim 6 wherein the delivery tube has an outer tube wall concentric with an inner tube wall, wherein the fluid is moved into and out of the mouthpiece through the inner and outer tube walls simultaneously.

8. The fluid jet bristle aggitation toothbrush fixture of claim 6 wherein the pressurizing means is a fluid pump.

9. The fluid jet bristle aggitation toothbrush fixture of claim 6 wherein the handle provides a fluid reservoir.

10. The fluid jet bristle aggitation toothbrush fixture of claim 6 wherein the fluid pump is enabled for pulsation pumping of the fluid.

11. A fluid jet bristle aggitation toothbrush fixture comprising:
a U-shaped mouthpiece;
a delivery tube engaged at one end thereof with the mouthpiece, and at an opposing end thereof with a handle;
the mouthpiece having an outer wall enclosing a hollow space therein, the outer wall configured as a well sized for receiving plural teeth;
a plurality of apertures in the outer wall, the apertures positioned and extensive for directing a fluid within the hollow space into the well;
a plurality of bristles mounted on the outer wall within the well in positions for fluid impingement by the fluid exiting the apertures;
a means for pressurizing the fluid in the hollow space.

12. The fluid jet bristle aggitation toothbrush fixture of claim 11 wherein the delivery tube has an outer tube wall concentric with an inner tube wall, wherein the fluid is moved into and out of the mouthpiece through the inner and outer tube walls simultaneously.

13. The fluid jet bristle aggitation toothbrush fixture of claim 11 wherein the pressurizing means is a fluid pump.

14. The fluid jet bristle aggitation toothbrush fixture of claim 11 wherein the handle provides a fluid reservoir.

15. The fluid jet bristle aggitation toothbrush fixture of claim 11 wherein the fluid pump is enabled for pulsation pumping of the fluid.
